(19) United States
(12) Patent Application Publication
(10) Pub. No.: US 2011/0283898 A1
(43) Pub. Date: Nov. 24, 2011

(54) Wickets, Wicketting Machines and Methods of Binding Packaging Bags

(76) Inventor: Marc Dufault, Tilbury (CA)

(21) Appl. No.: 13/110,262

(22) Filed: May 18, 2011

Related U.S. Application Data
(60) Provisional application No. 61/347,107, filed on May 21, 2010.

(51) Int. Cl. B65B 13/02; B30B 9/30

(52) U.S. Cl. 100/2; 100/8

(57) ABSTRACT

The present invention provides improved wickets, wicketting machines and methods for the binding of packaging bags. In one exemplary embodiment, the present invention provides an apparatus for binding packaging bags. The apparatus includes a first tubular member and a second tubular member. The apparatus further includes a first bracket plate defining a first opening for receiving the first tubular member and a second opening for receiving the second tubular member. The apparatus further includes a second bracket plate defining a first opening for receiving the first tubular member and a second opening for receiving the second tubular member. The second bracket plate includes a first engagement feature for engagement with the first tubular member and a second engagement feature for engagement with the second tubular member, the first and second engagement features being configured to resist movement of the second bracket plate with respect to the first bracket plate.

### CROSS-REFERENCE TO RELATED APPLICATION

The present application claims benefit of U.S. Provisional Patent Application No. 61/346,107, filed May 21, 2010, the contents of which are hereby incorporated by reference in its entirety for all purposes.

### FIELD OF THE INVENTION

The present invention relates to devices, machines and methods for the binding and packaging bags.

### BACKGROUND

Plastic packaging bags are used in a variety of packaging applications and are often needed to be readably available. Specific examples of industries utilizing plastic packaging bags include retail stores (e.g., grocery stores, hardware stores or otherwise), food processing facilities (i.e. bakeries or otherwise), packaging facilities for consumer goods or otherwise. In certain industries, large volumes of plastic bags are used to provide products to consumers, such as in high mass production facilities. In these industries, plastic bags must be particularly provided, e.g. prepared, cut and stacked for automated equipment to utilize such bags. In these applications, many stacks of plastic bags are used leaving many remnants, such as binding material, that must be disposed of. Unfortunately, much of the binding material used are made of non-recyclable or difficult to recycle material due to the variety of material being used and shape of the binding material. For example, certain prior wickets include steel rods, washers, cardboard backing and in some cases rubber end tips. These wickets could add as much as 40% to 70% to the basic cost of the steel rods.

In another aspect, it is also desirable to provide bags that can be made available for automated equipment of mass production facilities. Prior systems have utilized wickets and wicketting machines for the purpose of stacking and binding packaging bags together. However, these systems and machines have lead to laborious endeavors in the stacking and binding of bags. For example, while certain machines are capable of stacking bags, often the stacked bags are manually lifted and placed on holders for further processing, such as binding. In another example, wickets provided for use with wicketting machines are too flimsy or flexible so as to be difficult if not impossible to utilize with wicketting machines. In still another example, even with the use of wickets particularly configured for use with wicketting machines, multiple steps of manual labor are still required to bind the packaging bags together thereby negating much of the time and energy saved through a wicketting machine.

In view of the foregoing, there is a need for an improved wicket, wicketting machine and method for the binding of packaging bags for high production manufacturing facilities or otherwise.

### SUMMARY OF THE INVENTION

The present invention provides improved wickets, wicketting machines and methods for the binding of packaging bags which improves upon the shortcoming of the prior systems mentioned herein. Through the features of the present invention, an improved recyclable wicket is provided for easy use with new or existing wicketting machines, which reduces the amount of physical labor necessary for the binding of packaging bags, and provides improved workplace ergonomics by reducing or eliminating repetitive assembly steps.

In one aspect, the present invention provides an improved wicket for binding of plastic bags or other stackable members. The wicket includes hollow tubular members which provide improved stiffness to the wicket, which is particularly advantageous during attachment or mounting of bags to the wicket. The wicket is made of 100% recyclable plastic, which reduces landfills and prevents rust or other corrosion or deterioration concerns. The wicket also reduces the amount of wicket components, as compared to prior systems, is 65% lighter than prior wicket systems and has no sharp corners or edges. Other advantages will be appreciated as shown and described herein.

In view of the foregoing, in one exemplary embodiment, the present invention provides an apparatus for binding packaging bags. The apparatus includes a first tubular member extending between a first end and a second end and a second tubular member extending between a first end and a second end. The apparatus further includes a first bracket plate defining a first opening for receiving the first tubular member and a second opening for receiving the second tubular member. The first bracket plate is disposed proximate the first end of the first and second tubular members. The apparatus also includes a second bracket plate defining a first opening for receiving the first tubular member and a second opening for receiving the second tubular member. The second bracket plate is disposed from the first bracket plate, wherein the second bracket plate includes a first engagement feature for engagement with the first tubular member and a second engagement feature for engagement with the second tubular member. The first and second engagement features are configured to resist movement of the second bracket plate with respect to the first bracket plate.

In another exemplary embodiment, the present invention provides a method of binding packaging bags. The method includes the steps of providing a wicketting machine including an indexing belt and a rotary hub, the indexing belt includes a plurality of collectors each including a first spindle and a second spindle, wherein the rotary hub is configured to mount a plurality of packaging bags to the first and second spindles of the collectors. The method also includes placing a first hollow tubular member over the first spindle and a second hollow tubular member over the second spindle. The method further includes connecting a first bracket plate to the first hollow tubular member and the second hollow tubular member. The method still further includes mounting a plurality of packaging bags to the first hollow tubular member and the second hollow tubular member through the rotary hub. The method further includes connecting a second bracket plate to the first hollow tubular member and the second hollow tubular member, wherein the plurality of packaging bags are bound between the first and second bracket plate.

The above-described and other features and advantages of the present invention will be appreciated and understood by those skilled in the art from the following detailed description, drawings, and appended claims.

### BRIEF DESCRIPTION OF THE DRAWINGS

Other objects, features, advantages and details of the present invention appear, by way of example only, in the following detailed description of preferred embodiments of the invention, the detailed description referring to the drawings in which:

FIG. 1 illustrates an exemplary embodiment of a wicket according to the teachings of the present invention;

FIG. 2 illustrates an enlarged partial cross-sectional view of the wicket shown in FIG. 1;

FIGS. 3A through 3D illustrate views of an exemplary bracket plate of a wicket of the present invention;

FIGS. 4A through 4E illustrate views of another exemplary bracket plate of a wicket of the present invention;

FIGS. 5A through 5E illustrate views of another exemplary bracket plate of a wicket of the present invention;

FIG. 6 illustrates additional exemplary embodiments of bracket plates of a wicket of the present invention;

FIGS. 7A through 7D illustrate views of an exemplary hollow tubular member of a wicket of the present invention;

FIGS. 8A through 8D illustrate views of another exemplary hollow tubular member of a wicket of the present invention; and

FIGS. 9 through 15 illustrate perspective views of an exemplary embodiment of a wicketting machine during various stages of package bag binding according to the teachings of the present invention.

### DESCRIPTION OF THE PREFERRED EMBODIMENTS

In general, the present invention relates to devices, machines and methods for the binding packaging bags. The features of the present invention provide lower cost in the assembly and binding of packaging bags, or other stackable members, by reducing required material usage and man power for such binding. The features of the present invention further provide improved ergonomics in the workplace by reducing tedious and repetitive manual labor. Other features will be appreciated as shown and described herein.

In one aspect, the present invention is predicated upon a new and improved binding device that can be incorporated into new or existing binding machines. These binding devices replace non-recyclable, or difficult to recycle, binding devices with recyclable biding devices. In one aspect, the present invention provides a wicket configured for binding together packaging bags or other stackable members. The wicket is formed of recyclable material and is configured for use with existing wicketting machines, modified wicketting machines or new wicketting machines. In another aspect, the present invention provides a wicketting machine configured for use with the wickets described herein or otherwise. In yet another aspect, the present invention provides improved methods for binding packaging bags together.

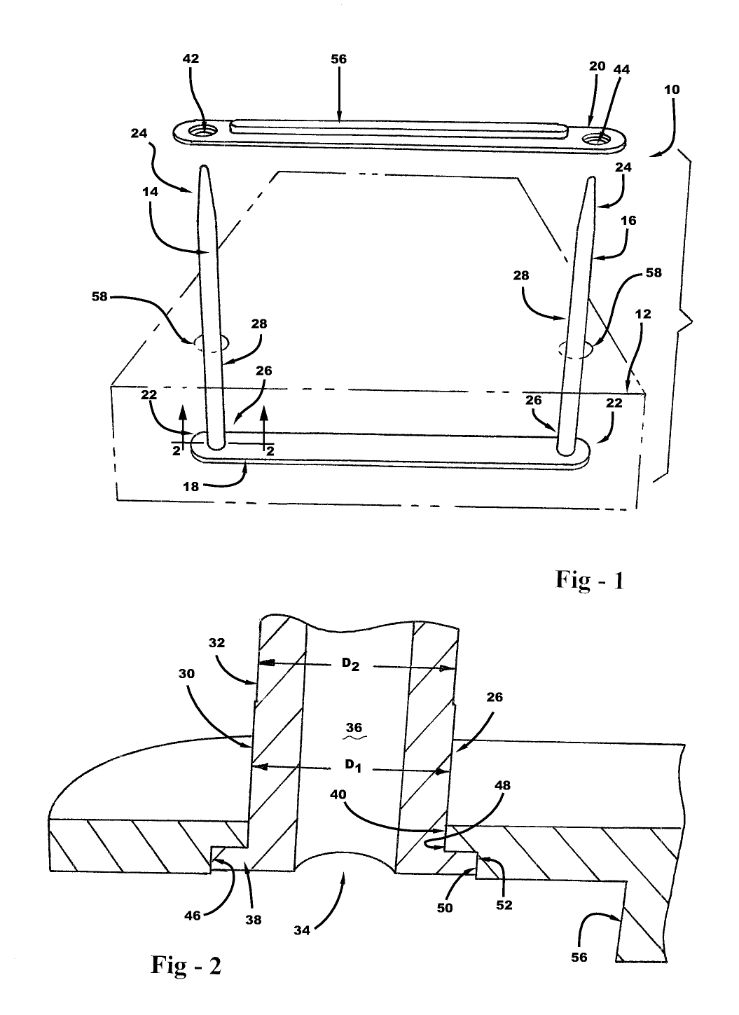

In general, referring to FIG. 1, an exemplary wicket 10 of the present invention is shown configured for binding and maintaining together packaging bags 12 or other stackable members. The wicket 10 includes a first tubular member 14 and a second tubular member 16. The first and second tubular members 14, 16 are engageable with a first bracket plate 18 at a first end and a second bracket plate 20 at an opposing end or between the first and second ends. The first and second tubular members 14, 16 are placed through openings 58 formed through the packaging bags 12, which prevents lateral movement of the packaging bags 12 with respect to the first and second tubular members. The first bracket plate 18 prevents movement of the packaging bags 12 in a first direction while the second bracket plate 20 prevents movement of the packaging bags 12 in a second direction.

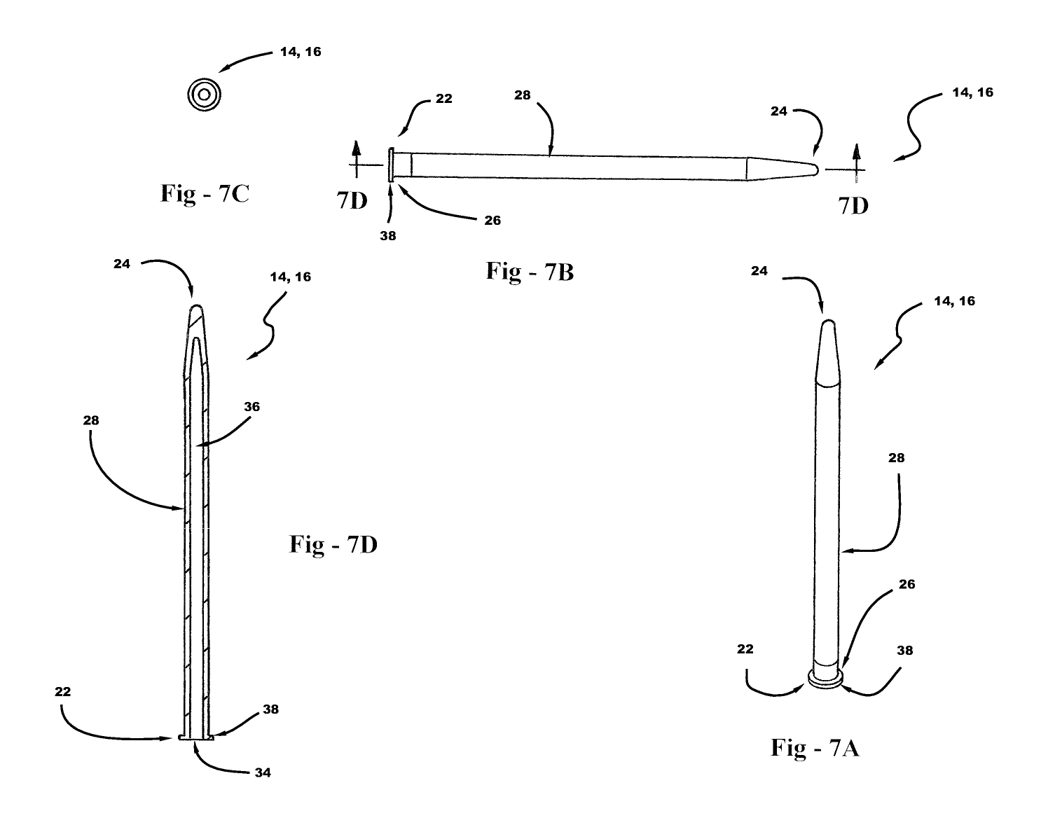

In greater detail, referring to FIGS. 1 through 8D, the first and second tubular members 14, 16 include a first or base end 22 and second or opposing end 24. In one exemplary embodiment, the first and second tubular members 14, 16 include one or more engagement features 26 for engagement with the first bracket plate 18, the second bracket plate 20 or both. In one particular exemplary embodiment, referring to FIGS. 2 and 7A through 7D, a friction fit is formed between the tubular portion 28 of the first and second tubular members 14, 16 and the first bracket plate 18. More specifically, in one exemplary embodiment the first and second tubular members 14, 16 include a first outer tubular portion 30 disposed proximate the base end 22, which includes a first diameter ‘D1’, and a second outer tubular portion 32 disposed at or between the opposing end 24 and the base end 22, which includes a second diameter ‘D2’. In one exemplary embodiment, the first diameter D1 is greater than the second diameter D2. In one exemplary embodiment, the first diameter D1 forms a friction fit between the first and second tubular members 14, 16 and the first bracket plate 18, and in one particular configuration also the second bracket plate 20.

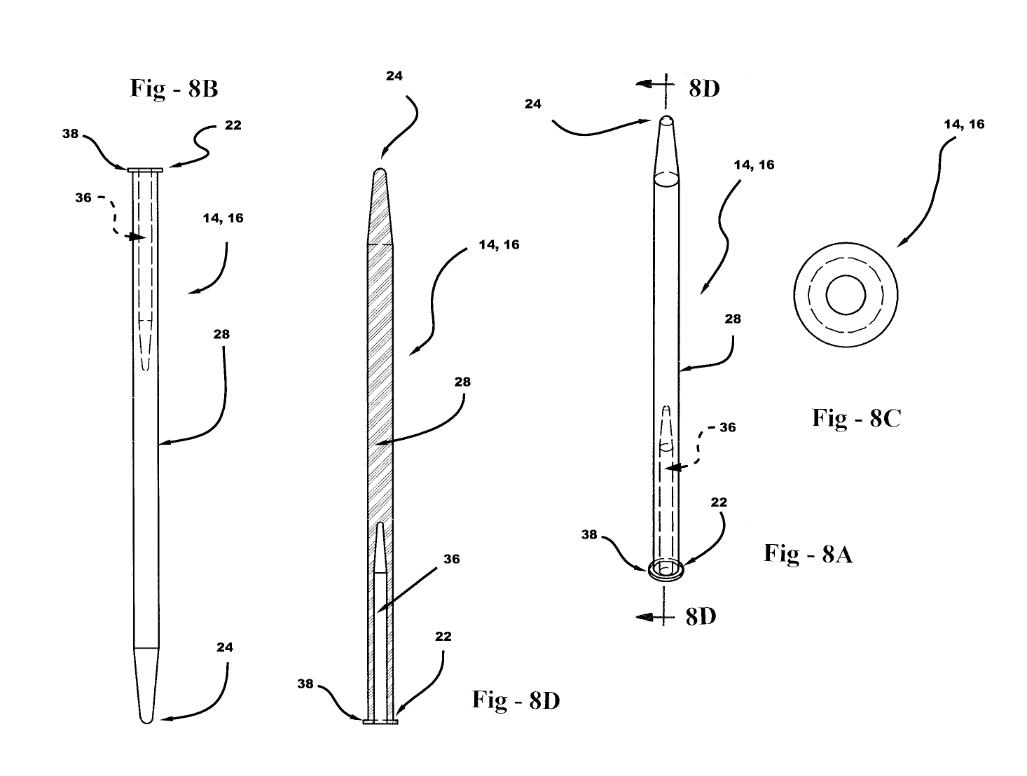

In another exemplary embodiment, the second diameter D2 forms a friction fit between the first and second tubular members 14, 16 and the second bracket plate 20. In yet another exemplary embodiment, referring to FIGS. 8A through 8D, the tubular portion 28 includes a generally constant diameter that extends from the base end 22 to proximate the opposing end 24. In this configuration, the tubular portion 28 includes a diameter suitable for forming a friction fit between the first and second tubular members 14, 16 and the first bracket plate 18, and in one particular configuration also the second bracket plate 20.

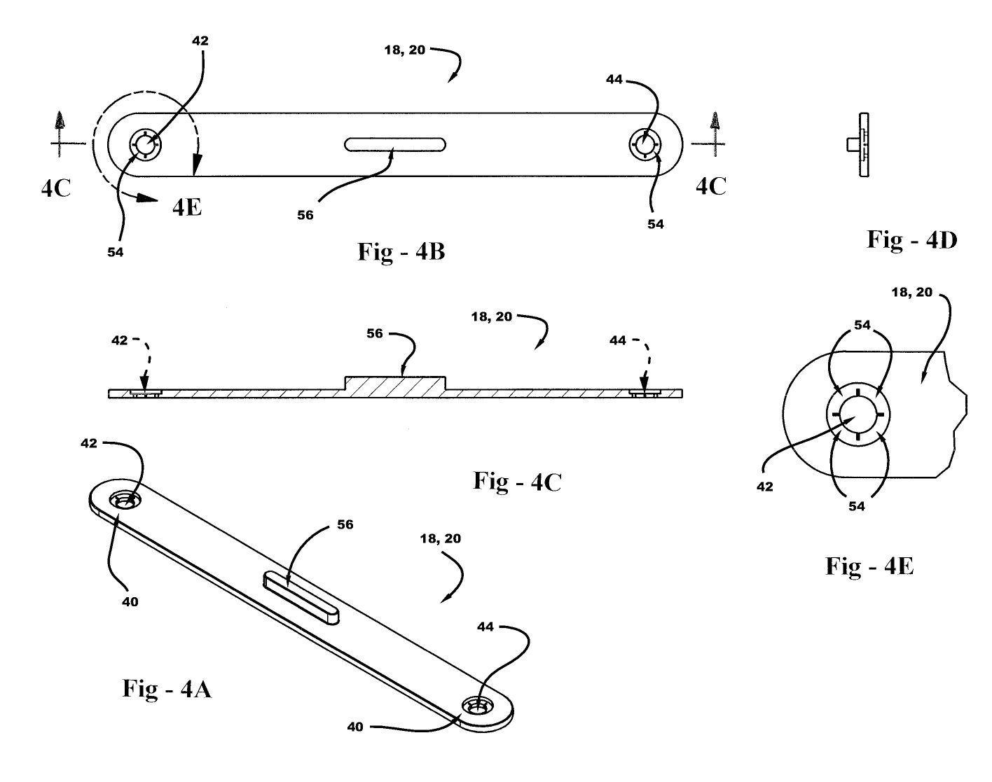

Advantageously, in either configuration shown in FIGS. 7A through 7D or FIGS. 8A through 8D, the first and second tubular members 14, 16 may include a diameter particularly configured to form a friction fit with a first or second bracket plate 18, 20 having flexible resilient friction members 54, such as shown in FIGS. 4A through 4E and as described further herein. Advantageously, the resilient flexibility of the friction members 54 provide the ability to receive different size tubular members, which is particularly useful for accounting for variances of material dimensions. Accordingly, it is contemplate that the first diameter D1, second diameter D2, the diameter of the tubular portion 28 or all three are greater, equal or even slightly smaller than the diameters of the first opening 42, second opening 44 or plurality of openings 45. Also, while the drawings indicate four flexible resilient friction members 54 per opening 42, 44, 45, other advantageous friction member configurations are contemplate such as 1, 2, 3 or more friction members per opening.

The first and second tubular members 14, 16 include an opening 34 leading to a cavity 36 extending between the base and opposing end 22, 24 of the tubular members. Advantageously, as described herein, the opening 34 and cavity 36 are configured for receiving and engagement with a corresponding component of a wicketing machine, such as spindles. In a first example, referring to FIGS. 7A through 7D, the cavity 36 extends between the base and opposing end 22, 24 of the first and second tubular members 14, 16. In a second example, referring to FIGS. 8A through 8D, the cavity 36 extends from the base end 22 to a middle region of the first and second tubular members 14, 16. In either configuration, the opening 34 and cavity 36 are suitable in size and shape for receiving spindles associated with a wicketting machine, as described herein. In one exemplary embodiment, the internal walls forming cavity 36 include a layer of friction reducing material, such as a wet or dry lubricant or friction reducing coating or layer, is shaped having an increasing diameter towards the base end 22 to reduce friction during placement on or removal from a spindle as shown, and described herein, or combinations thereof.

The first and second tubular members 14, 16 further include an annular lip 38 extending from the base end 22. The annular lip 38 limits movement of the first bracket plate 18 with respect to the first and second tubular members 14, 16. In one configuration, the first bracket plate 18 is configured to matingly engage with the annular lip 38 of the first and second tubular members 14, 16.

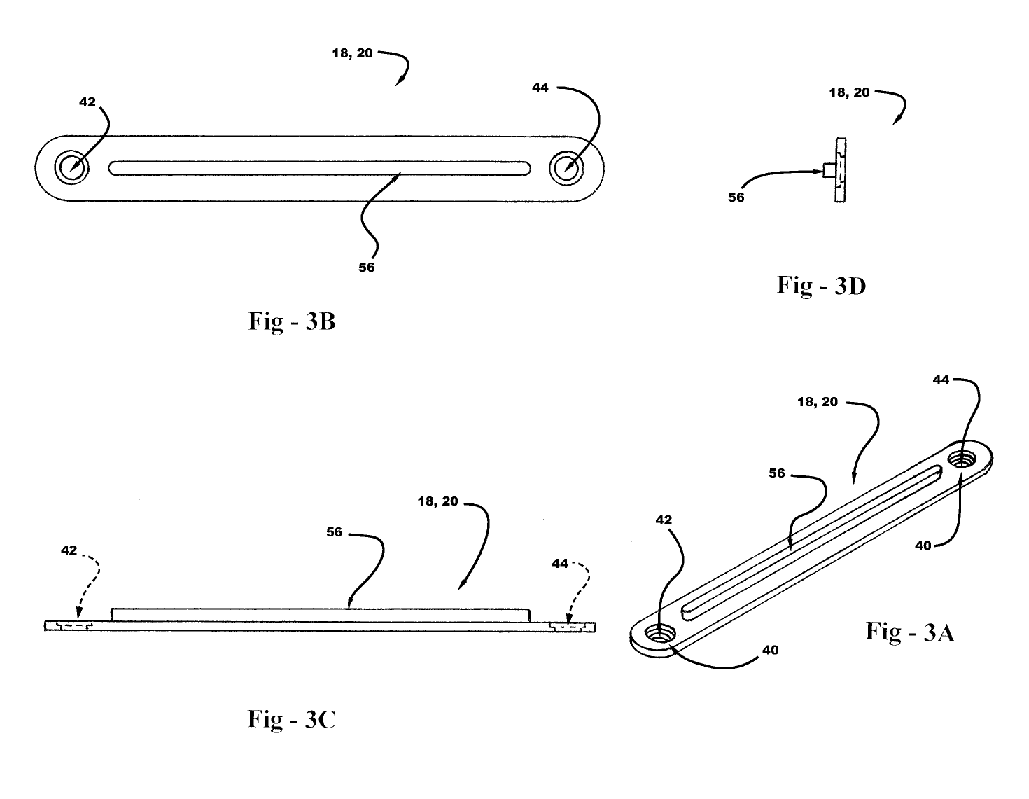

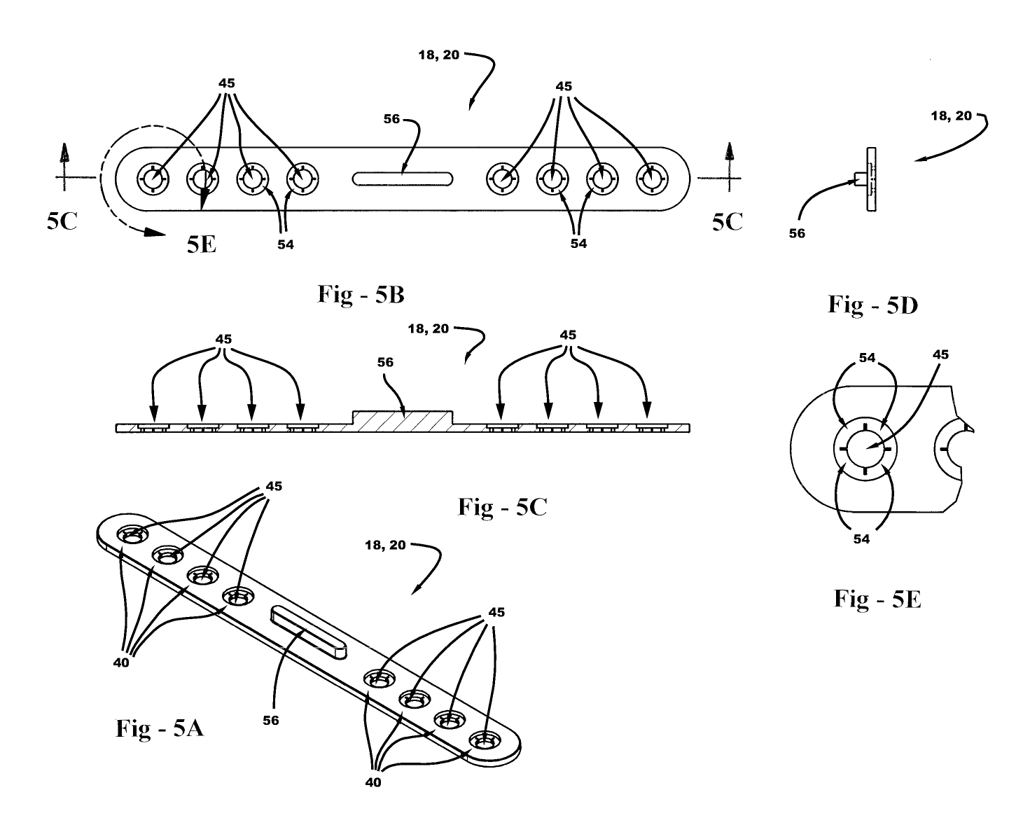

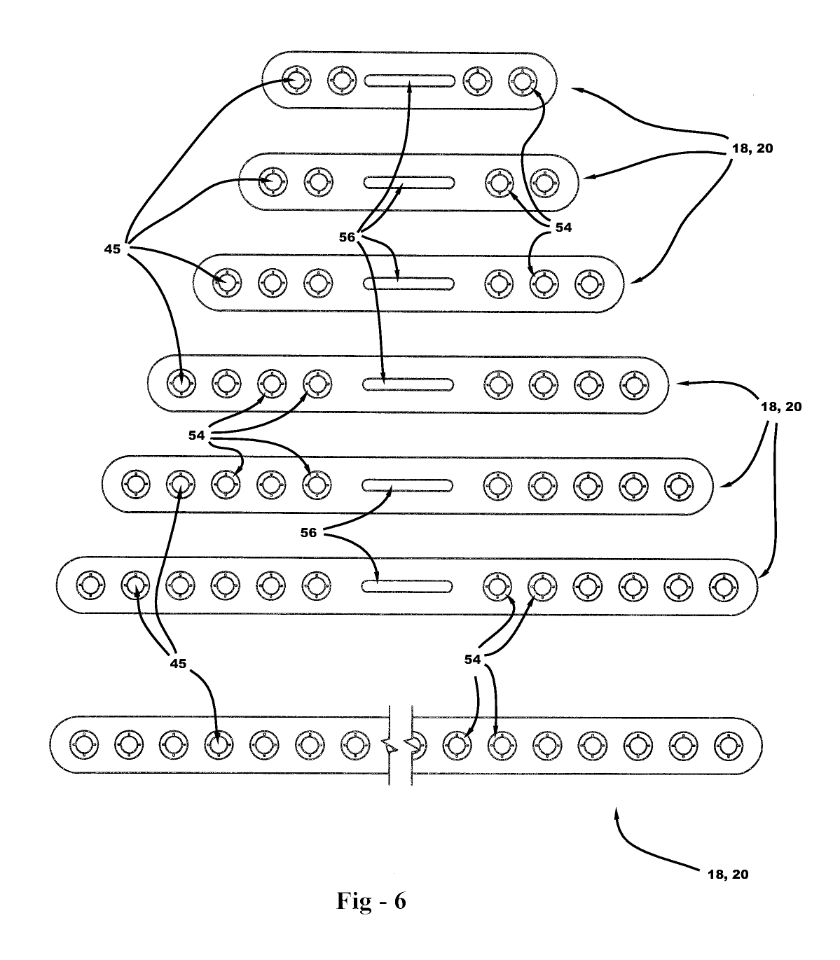

Referring to FIGS. 3A through 6, the first and second bracket plate 18, extend between a first end and a second end and include corresponding engagement features 40 to the engagement feature 26 of the first and second tubular members 14, 16. In one exemplary embodiment, the engagement features comprise openings formed through the first and second bracket plates 18, 20 that are configured to receive first and second tubular members. For example, in one exemplary embodiment, the first and second bracket plate 18, 20 include a first opening 42 for receiving and engaging the first tubular member 14 and a second opening 44 for receiving and engaging the second tubular member 16. In another exemplary embodiment, referring particularly to FIGS. 5A through 5E and FIG. 6, the first and second bracket plate 18 includes a plurality of openings 45 formed between the ends of the bracket plates. In one particular exemplary embodiment, the plurality of openings 45 form a plurality of first openings 42 and a plurality of second openings 44. Advantageously, the plurality of openings adds to the versatility of potential applications since the distance between binding can be relatively small for smaller bag applications or can be relatively large for larger bag applications. Accordingly, a single bracket plate configuration can be used for multiple applications and devices, i.e. wicketting machines or otherwise. Additionally, in certain application it is desirous to use more than a first and second tubular members 14, 16 but instead a plurality of first and second tubular members or even a plurality of tubular members corresponding to the number of openings formed through the first and second bracket plates 18, 20 or otherwise.

In one exemplary embodiment, as described above, the first bracket plate 18, and optionally second bracket plate 20, include a recess 46 for receiving and engaging the annular lip 38 of the first and second tubular members 14, 16. In one particular configuration, it is contemplated that a friction fit is formed between the first outer tubular portion 30 and an inner portion 48 of the first and second opening 42, 44, between an outer portion 52 of the annular lip 38 and inner portion 50 of the recess 46, or both. For example, as previously describe, and as shown in FIG. 2, a friction fit is formed between a tubular portion 28 and more specifically between a first outer tubular portion 30 and second outer tubular portion 32 and the first and second openings 42, 44 of first and second bracket plate 18, 20.

In another exemplary embodiment, referring to FIGS. 4A through 6, the first and second bracket plates 18, 20 include a one or more, or plurality, of resilient flexible friction members 54 for engagement with the first and second tubular members 14, 16. In one particular embodiment, the resilient flexible friction members 54 form the first and second openings 42, 44 of the first and second bracket plates 18, 20. Further, in one configuration, the openings formed by the resilient flexible friction members 54 form a diameter that is smaller than an outer diameter of the tubular portion 28, first outer tubular portion 30, second outer tubular portion 32 or both. In this configuration, as the first and second tubular members 14, 16 are inserted through the first and second openings 42, 44, the resilient flexible members 54 move and flex to create a larger openings for receiving the first and second tubular members 14, 16. Upon completion of insertion, the resiliency of the resilient flexibly friction members 54 forms a friction fit with the first and second tubular members 14, 16.

In one exemplary embodiment, the first bracket plate 18, second bracket plate 20, or both, include a reinforcement rib or locating member 56 extending between the first end and second end of the bracket plate. In one application, a reinforcement rib 56 is provided and configured to increase stiffness of the first and second bracket plates 18, 20 and hence the wicket 10. The suitable stiffness may be based upon the weight or other characteristics of the packaging bags 12. In another application, a locating member 56 may be provided for locating the wicket and hence stack of packaging bags 12 in an automated machine for aiding in the distribution of individual packaging bags.

For example, referring to FIGS. 3A through 3D, the first bracket plate 18, second bracket plate 20, or both, include a reinforcement rib or locating member 56 that extend between the first opening 42 and second opening 44 and extends symmetrically along a majority of the length of the bracket plate. In another example, referring to FIGS. 4A through 4D, the first bracket plate, second bracket plate 20, or both, include a reinforcement rib or locating member 56 that is centrally located and extends symmetrically only a portion of the length of the bracket plate, such as less than about 50% of the length of the bracket plate or even about 25% of the length of the bracket plate. The length of the reinforcement rib or locating member 56 can be based upon material consideration, stiffness requirements and wicketting machine requirements.

In use, referring again to FIGS. 1 and 2, in one exemplary embodiment of the wicket 10, the first and second openings 42, 44, or plurality of openings 45, of the first bracket plate 18 are aligned with the first and second tubular member 14, 16, or plurality of tubular members, respectively. The first and second tubular members 14, 16 are inserted into the first and second openings 42, 44 until the annular lip 38 of the first and second openings are seated into the recess 46 of the first bracket plate 18. A friction fit is formed between first outer tubular portions 30 and the inner portions 48 of the first and second openings 42, 44 to cause engagement therebetween. Openings 58 of one or more, or stack, of packaging bags 12 are then positioned over the first and second tubular members 14, 16 and the first and second tubular members are inserted through the openings 58 until the packaging bags 12 come to rest against the first bracket plate 18. The first and second openings 42, 44 of the second bracket plate 20 are then aligned with the first and second tubular member 14, 16, respectively. The first and second tubular members 14, 16 are inserted into the first and second openings 42, 44 until the second bracket plate 20 is adjacent the packaging bags 12. A friction fit is formed between the second outer tubular portions 32 and the inner portions 48 of the first and second openings 42, 44 to cause engagement therebetween. The first and second bracket plates 18, 20 are engaged with the first and second tubular members 14, 16 to bind and maintain position of the packaging bags 12 with respect to the wicket 10.

While the present invention is shown as including first and second tubular members, it should be appreciated that the wicket 10 may include more or less tubular members 14, 16. For example, it is contemplated that the wicket may include 1, 2, 3, 4, 6, 8, 10, 12 or more tubular members. And, it is contemplated that the first and second bracket plates 18, 20 include 1, 2, 3, 4, 6, 8, 10, 12 or more openings for receiving tubular members 14, 16. Further, it is contemplated that the number of tubular members may correspond to the number of openings formed through the first and second tubular member 14, 16. For example, referring to FIG. 6, first and second bracket plates 18, 20 are shown including multiple openings 45. This configuration provides the ability to utilize bags having openings 58 of different displacement or bags having more than two openings 58 for receiving additional tubular, or other, members for additional binding strength.

The wicket may be formed of any material suitable in strength for binding the packing bags 12. The components forming the wicket may be formed of similar or dissimilar materials. However, in one exemplary embodiment, the components forming the wickets, i.e. tubular members and bracket plates, are formed of a recyclable material and more particularly a recyclable plastic material. Accordingly, upon completion of use of the wicket 10, i.e. use of the packaging bags 12, the entire wicket is sent to a recycling facility for recycling or back to a manufacture of the packaging bags 12 for reuse. In one exemplary embodiment, the components of the wicket are formed of plastic and in one particularly exemplary embodiment a recyclable plastic. Contemplated materials for any or all of the components of the wicket 10 include plastic, metal, rubber, composite materials, combinations thereof or otherwise.

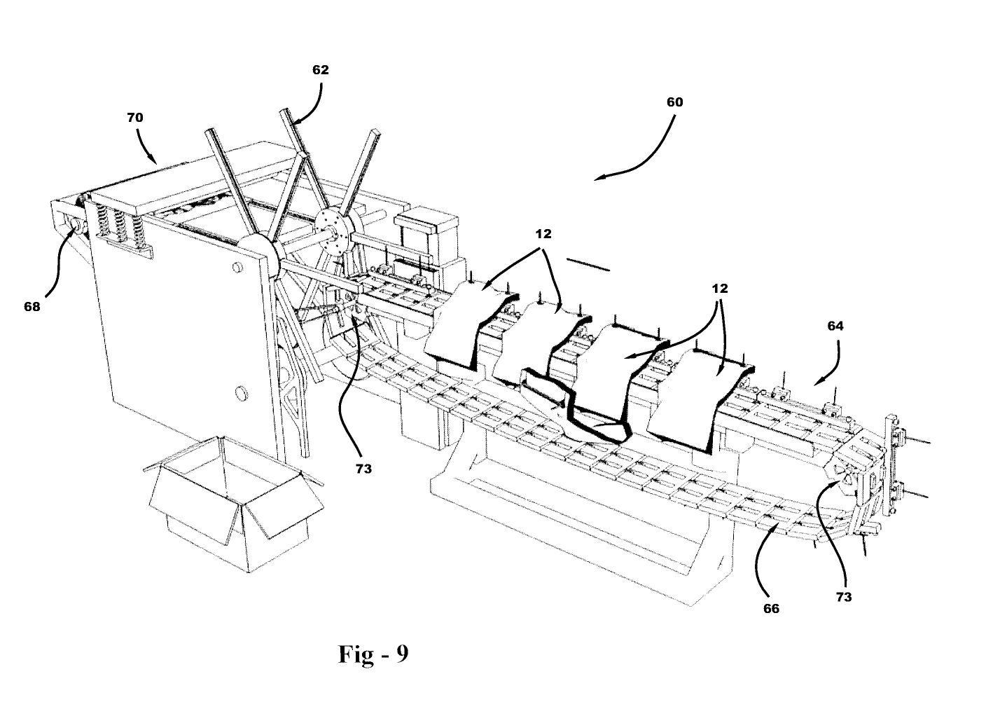

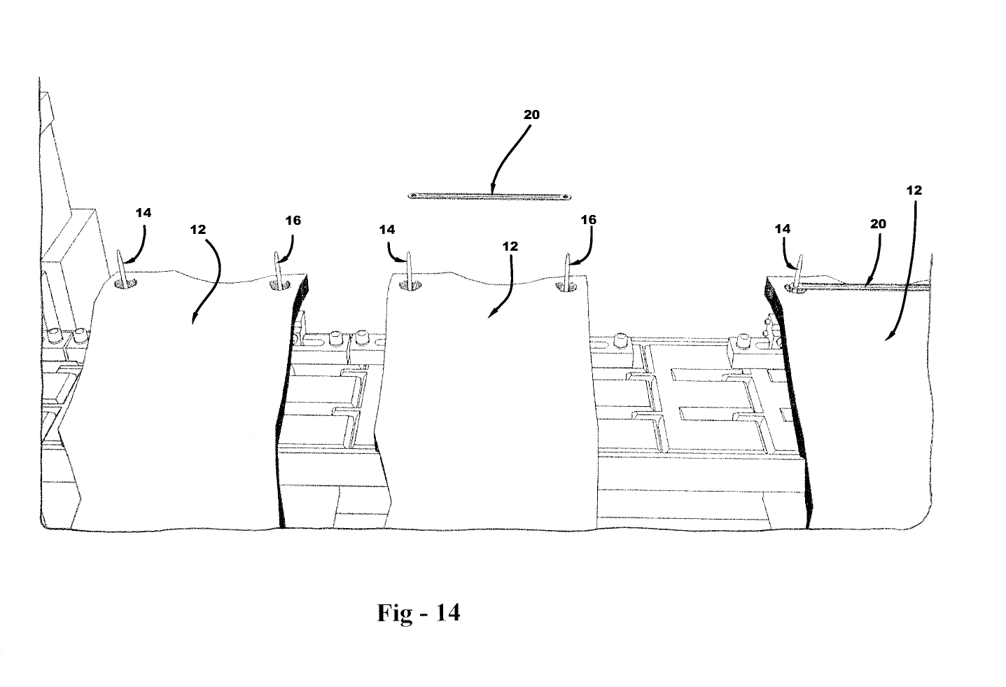

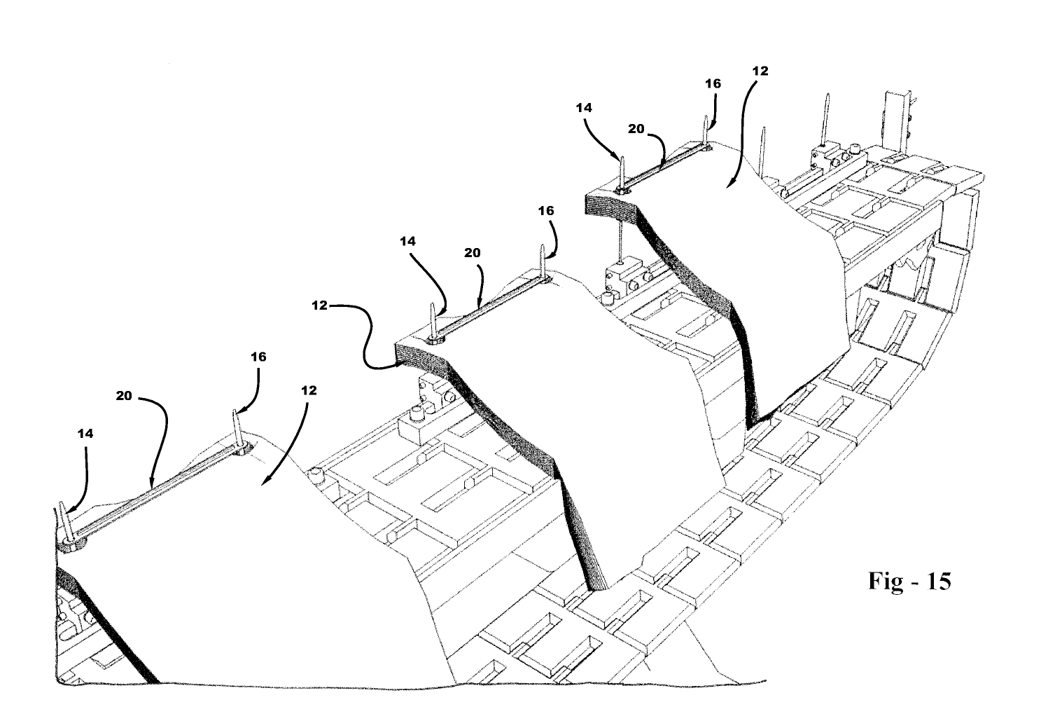

Referring to FIGS. 9 through 15, the present invention further contemplates a wicketting machine 60 configured for the binding of packaging bags 12 through the wicket 10 of the present invention or otherwise. The wicketting machine 60 includes a rotary hub 62 for selection and placement of packaging bags 12 onto collectors 64 of an indexing belt 66. In the configuration shown, the bags originate from a material supply 68 and are hole-punched, cut, shaped and otherwise prepared at a forming station 70. Upon completion, the rotary hub 62 selectively moves the bag from the forming station 70 to the collectors 64.

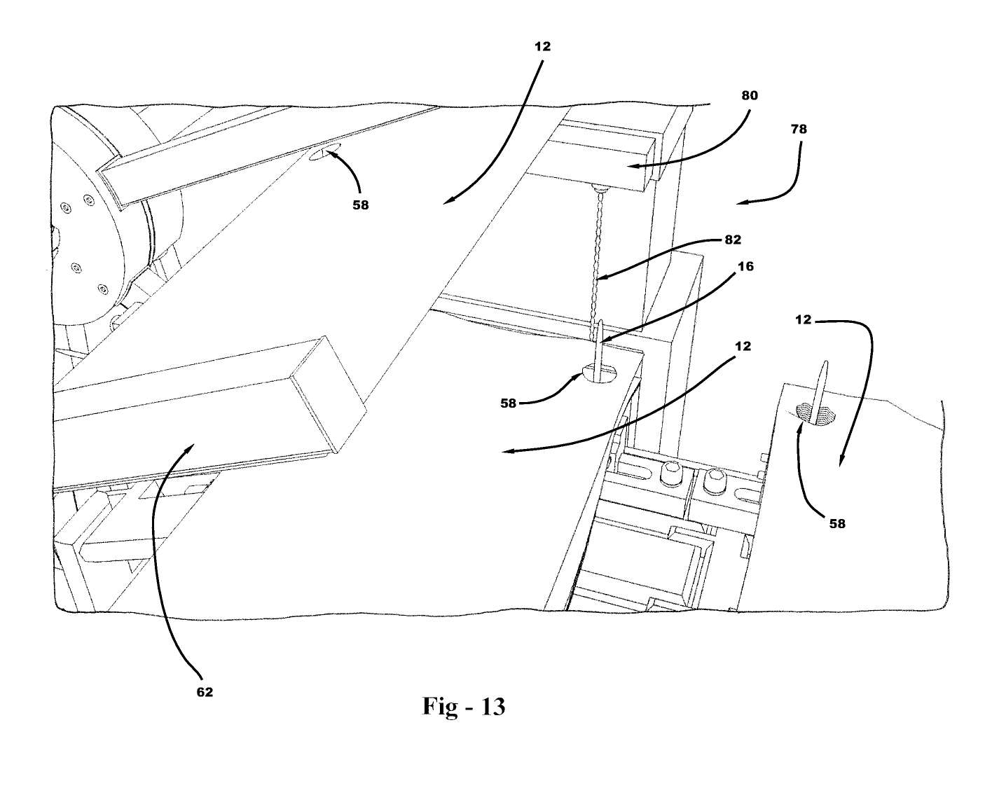

The collectors 64 include a spindle bracket mount 72 configured for attachment to the indexing belt 66, which allows free movement of the collectors as the belt moves 360° about rollers 73. The collectors 64 further include spindle brackets 74, 75 each including a spindle 76, 77 extending therefrom. In the exemplary embodiment shown, the collectors 64 include two spindle brackets 74, 75 and spindles 76, 77. However, more or less may be used consistent with the wicket 10 configuration being used, as described herein. Referring to FIG. 13, the spindle brackets 74, 75 are positioned to cause alignment of openings 58 formed through the packaging bags 12 with the spindles 76, 77 such that as the rotary hub 62 moves past the spindle brackets the spindles become inserted into openings formed through the packaging bag. This process repeats until a desired amount of bags are attached to the collectors wherein, thereafter, the indexing belt 66 moves to cause alignment of another collector with the rotary hub 62. The indexing belt 66 is rotated through a suitable motor.

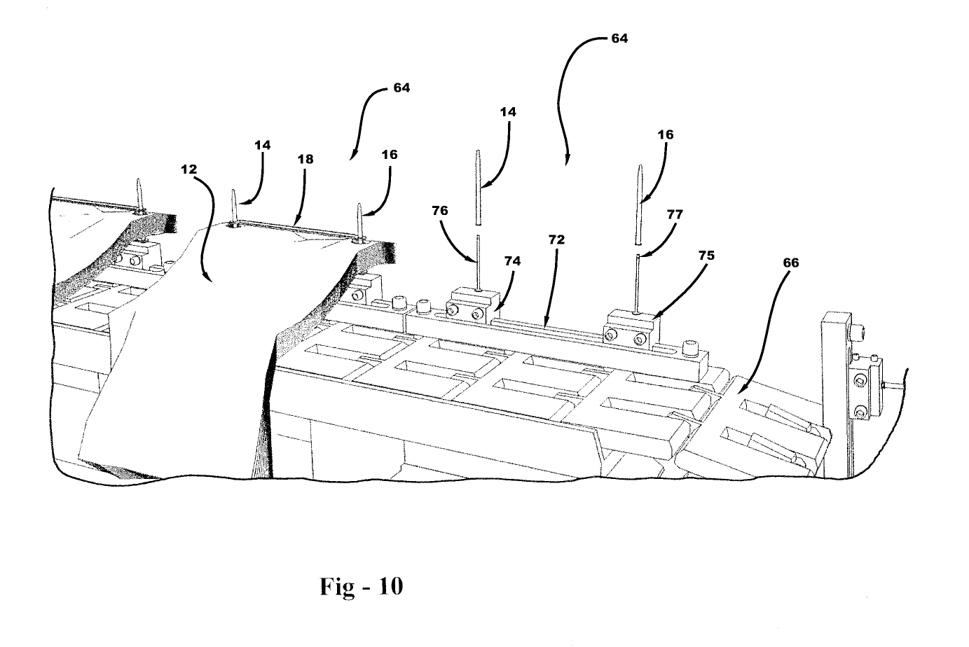

In one exemplary embodiment, referring to FIGS. 10 through 12, the wicketting machine 60 further contemplates use of the wickets 10 described herein. In one configuration, the first and second tubular members 14, 16 are placed upon the spindles 76, 77. This may be achieved manually or in one preferred configuration through an automated robotic tubular member applicator. Once the collectors 64 are aligned with the rotary hub 62, a first bracket plate 18 is selected, aligned with first and second tubular members 14, 16 and lowered to cause insertion of the first and second tubular members into a first and second opening 42, 44 of the bracket plate. In one exemplary embodiment, an engagement configuration, e.g. engagement feature 26 and 40, causes the first bracket plate to become engaged with the first and second tubular member.

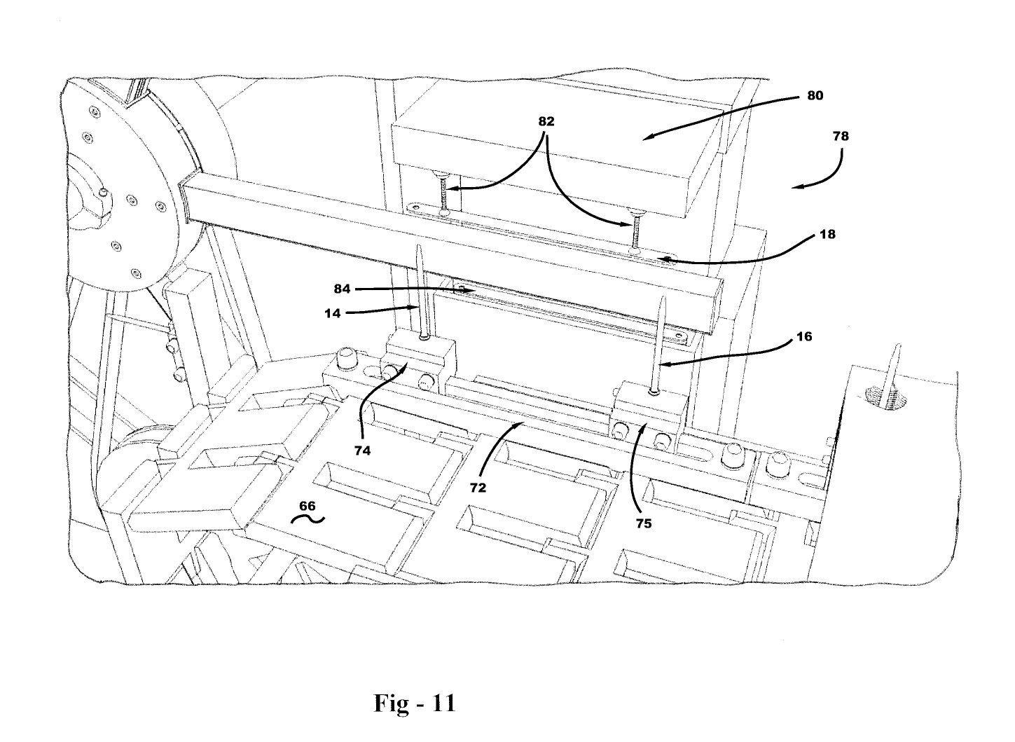

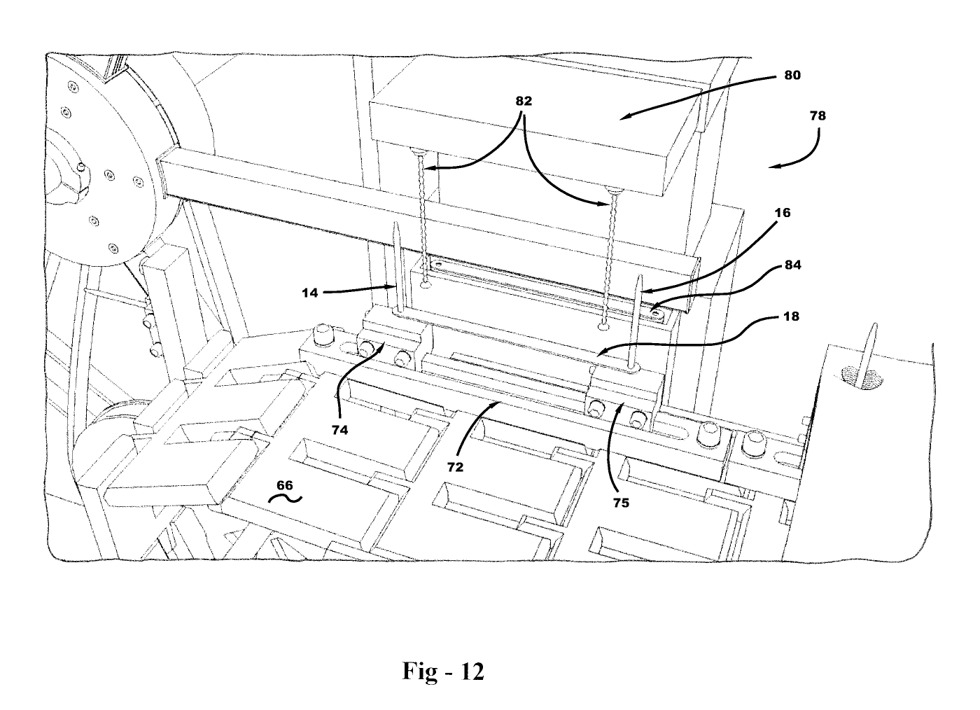

Referring to FIGS. 11 and 12, in one exemplary embodiment, engagement of the first bracket plate 18 with the first and second tubular members 14, 16 is achieved through an automated robotic applicator 78 configured for selective engagement with a first bracket plate, alignment of the first bracket plate with the first and second tubular member and engagement of the first bracket plate with the first and second tubular member. The automated robotic applicator 78 includes an extendable arm 80 and two opposing grasp mechanisms 82 configured for selectively grasping of a first bracket plate 18. The selective grasping may be achieved through pneumatics means, mechanical means, electrical means or other suitable means. The extendable arm 80 aligns the grasp mechanisms 82 with a first bracket plate supply 84 and the first and second tubular members 14, 16. The grasp mechanisms 82 are configured to raise and lower to selectively gasp a first bracket plate 18 from the bracket plate supply 84 and engage the first bracket plate with the first and second tubular members 14, 16.

Referring to FIGS. 13 through 15, after a desired amount of packaging bags are attached to the first and second tubular member 14, 16, a second bracket plate 20 is aligned with the first and second tubular member and lowered to cause engagement with the first and second tubular member, thereby causing binding of the packaging bags 12. In one exemplary embodiment, the wicketting machine 60 further includes an automated robotic application, such as robotic applicator 78 or otherwise, for, selection, alignment and engagement of the second bracket plate 20 with the first and second tubular members 14, 16. However, selection, alignment and engagement of the second bracket plate 20 with the first and second tubular members may be performed manually.

In view of the forgoing advancements in wicket 10 and wicketting machines 60, still referring to FIGS. 9 through 15, the present invention further contemplates methods of binding packaging bags 12. In one configuration, the method includes providing a wicketting machine 60 including an indexing belt 66 and a rotary hub 62. The indexing belt 66 includes a plurality of collectors 64 each including a first spindle 76 and a second spindle 77, wherein the rotary hub is configured to mount a plurality of packaging bags 12 to the first and second spindle of the collectors. A first hollow tubular member 14 is placed over the first spindle 76 and a second hollow tubular member 16 is placed over the second spindle 77. A first bracket plate 18 is then aligned and connected to the first and second hollow tubular members by placing the tubular member into a first and second opening 42, 44 of the first bracket plate 18. The annular lip 38 extending about the first and second tubular members 14, 16 prevent the first bracket plate from slipping past the base end 22 of the tubular members. Packaging bags 12 are then attached to the first and second hollow tubular members by causing the opposing end 24 of the tubular members to be inserted through openings 58 of the packaging bags. A second bracket plate 20 is then aligned and connected to the first and second hollow tubular members 14, 16 by placing the tubular members into a first and second opening 42, 44 of the second bracket plate 20, wherein the plurality of packaging bags 12 are bound between the first and second bracket plate 18, 20. It should be appreciated that other steps may be included as shown and described herein.

While the invention has been described with reference to a preferred embodiment it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An apparatus for binding packaging bags, comprising:
a first tubular member extending between a first end and a second end;
a second tubular member extending between a first end and a second end;
a first bracket plate defining a first opening for receiving the first tubular member and a second opening for receiving the second tubular member, the first bracket plate being disposed proximate the first end of the first and second tubular members; and
a second bracket plate defining a first opening for receiving the first tubular member and a second opening for receiving the second tubular member, the second bracket plate being disposed from the first bracket plate, wherein the second bracket plate includes a first engagement feature for engagement with the first tubular member and a second engagement feature for engagement with the second tubular member, the first and second engagement features being configured to resist movement of the second bracket plate with respect to the first bracket plate.

2. The apparatus of claim 1, wherein the first engagement feature comprises a friction fit formed between an outer portion of the first tubular member and an inner portion of the first opening of the second bracket plate and the second engagement feature comprises a friction fit formed between an outer portion of the second tubular member and an inner portion of the second opening of the second bracket plate.

3. The apparatus of claim 1, wherein the first bracket plate includes a first engagement feature for engagement with the first tubular member and a second engagement feature for engagement with the second tubular member, the first and second engagement features of the first bracket plate being configured to resist movement of the first bracket plate with respect to the first and second tubular member.

4. The apparatus of claim 3, wherein the first engagement feature of the first bracket plate comprises a friction fit formed between an outer portion of the first tubular member and an inner portion of the first opening of the first bracket plate and the second engagement feature of the first bracket plate comprises a friction fit formed between an outer portion of the second tubular member and an inner portion of the second opening of the first bracket plate.

5. The apparatus of claim 1, wherein the first tubular member includes an opening disposed at the first end of the first tubular member that leads to a cavity that extends between the first end and the second end of the first tubular member, and wherein the second tubular member includes an opening disposed at the first end of the second tubular member that leads to a cavity that extends between the first end and the second end of the second tubular member.

6. The apparatus of claim 1, wherein the first end of the first tubular member includes an outwardly extending annular lip and the first end of the second tubular member includes an outwardly extending annular lip, the first and second outwardly extending annular lip includes a diameter that is greater than an inner diameter of the first and second opening of the first bracket plate.

7. The apparatus of claim 6, wherein the first bracket plate includes a first recess disposed about the first opening of the first bracket plate and a second recess disposed about the second opening of the first bracket plate, the first and second recess being configured to receive the first and second annular lip, respectively.

8. The apparatus of claim 1, wherein the first tubular member includes a first diameter disposed proximate the first end and a second diameter disposed between the first and second end, the first diameter being greater than the second diameter, and wherein the second tubular member includes a first diameter disposed proximate the first end and a second diameter disposed between the first and the second end, the first diameter being greater than the second diameter.

9. The apparatus of claim 1, wherein the first bracket plate includes a plurality of resilient flexible members disposed about the first opening and the second opening to form a friction fit with the first tubular member and the second tubular member, respectively.

10. The apparatus of claim 1, wherein the first bracket plate includes a reinforcement rib or locating member extending between a first end and a second end of the first bracket plate, and wherein the second bracket plate includes a reinforcement rib or locating member extending between a first end and a second end of the second bracket plate.

11. A method of binding packaging bags, the method comprising the steps of:
providing a wicketting machine including a indexing belt and a rotary hub, the indexing belt includes a plurality of collectors each including a first spindle and a second spindle, wherein the rotary hub is configured to mount a plurality of packaging bags to the first and second spindle;
placing a first hollow tubular member over the first spindle and a second hollow tubular member over the second spindle;
connecting a first bracket plate to the first hollow tubular member and the second hollow tubular member;
mounting a plurality of packaging bags to the first hollow tubular member and the second hollow tubular member through the rotary hub; and
connecting a second bracket plate to the first hollow tubular member and the second hollow tubular member, wherein the plurality of packaging bags are bound between the first and second bracket plate.

12. The method of claim 11, wherein the first and second hollow tubular members are manually placed over the first spindle and second spindle, respectively.

13. The method of claim 11, wherein the first and second hollow tubular members are placed over the first spindle and second spindle through a robotic mechanism.

14. The method of claim 11, wherein the first bracket plate includes a first opening for receiving the first hollow tubular member and a second opening for receiving the second hollow tubular member.

15. The method of claim 14, wherein connection of the first bracket plate to the first and second hollow tubular member is achieved through a robotic mechanism configured to align the first and second openings of the first bracket plate over the first and second hollow tubular members, respectively, and lower the first bracket plate to seat the first bracket plate to a base of the first and second hollow tubular members.

16. The method of claim 15, wherein upon seating a friction fit is formed between the first bracket plate and the first and second hollow tubular members.

17. The method of claim 16, wherein the robotic mechanism is configured to selectively couple to a bracket plate from a bracket plate supply.

18. The method of claim 11, wherein the first hollow tubular member includes an annular lip extending outward from a base of the first hollow tubular member and the second hollow tubular member includes an annular lip extending outward from a base of the second hollow tubular member, and wherein the first bracket plate further includes a first recess for receiving the first annular lip and a second recess for receiving the second annular lip.

19. The method of claim 18, wherein the second bracket plate includes a first opening for receiving the first hollow tubular member and a second opening for receiving the second hollow tubular member.

20. The method of claim 19, wherein a friction fit is formed between the second bracket plate and the first and second hollow tubular members.
